(19) United States
(12) Patent Application Publication
(10) Pub. No.: US 2023/0279569 A1
(43) Pub. Date: Sep. 7, 2023

(54) ARRANGEMENT TO OPTIMIZE THE PRODUCTION OF HYDROGEN

(71) Applicant: AW-ENERGY OY, Vantaa (FI)

(72) Inventor: Christopher RIDGEWELL, Helsinki (FI)

(21) Appl. No.: 18/030,152

(22) PCT Filed: Oct. 3, 2021
(86) PCT No.: PCT/FI2021/050649

§ 371 Date: Apr. 4, 2023

(30) Foreign Application Priority Data
Oct. 4, 2020 (FI) 20205968

(51) Int. Cl. C25B 15/02; C25B 1/04; C25B 9/65; C02F 1/44; C02F 1/00; F03B 13/12; F03D 9/00

(52) U.S. Cl. CPC C25B 15/02; C02F 1/008; C02F 1/441; C25B 1/04; C25B 9/65; F03B 13/12; F03D 9/008; C02F 2103/08; C02F 2201/009

(57) ABSTRACT

This invention relates to an arrangement to optimize the production of hydrogen, the arrangement comprising at least a solar energy unit (12) and a wave and/or tidal energy recovery system (2), which are arranged to produce renewable energy, a water purification unit (5) and an electrolysis unit (9), which is arranged to produce hydrogen from pure water produced by the water purification unit (5), and the electrolysis unit (9) and the water purification unit (5) are powered by the renewable energy produced by the solar energy unit (12) and the wave and/or tidal energy recovery system (2). The arrangement comprises a buffer unit (6), into which pure water is supplied from the water purification unit (5) during periods when the production of the renewable energy exceeds the need of energy of the electrolysis unit (9).

The present invention relates to an arrangement to optimize the production of hydrogen as defined in the preamble of claim 1.

According to prior art there are various types of hydrogen production systems. A common method to produce hydrogen is electrolysis. It is advantageous to locate an electrolysis plant on the sea or on the coast because of access to maritime trade routes for low cost export. An electrolysis plant needs pure water for hydrogen production and in some known solutions there is a water desalination system in connection with the electrolysis plant.

Some arrangements utilize renewable energy such as solar energy, wind energy and wave and/or tidal energy to produce energy for an electrolysis plant which produces hydrogen from water by electrolysis. Using renewable energy, harmful emissions can be reduced and so-called “Green Hydrogen” can been produced.

The prior art in the area of Green Hydrogen looks at the details of electrolysis and hydrogen storage methods rather than the complete system optimisation, including the water generation. Especially the fact that electrolysis equipment must be kept operational 24/7 is not considered. In some known systems power will be sourced from the grid once the sun sets, but this is exactly when the power is most costly.

Most known solutions are for small scale hydrogen production, where the national electricity grid and domestic water supply can be relied upon. However, these solutions are not adequate to supply the anticipated increase in demand. For example, for every tonne of Green Hydrogen, about 9 tonnes of water are needed. Thus, if Green Hydrogen is to grow significantly, existing fresh water resources are not sufficient in areas with a strong low cost solar energy potential. Thus, sea water is needed for hydrogen production and for local communities. Thus, this invention will have a significant impact in the transition to Green Hydrogen.

For Green Hydrogen to be adopted widely it must be generated from the cheapest form of renewable energy, which today is solar energy. Solar energy shuts down in the night, but the shutdown and restart of hydrogen electrolysis equipment must be avoided. This is harmful for the electrolysis equipment and harmful for the entire process. Thus, electricity could be sourced from the national grid, but this electricity is generally more costly when the sun sets and is generated from non-renewable sources.

Alternatively, energy can be stored in electrical batteries during daylight hours and released to the electrolysis process during the night. But this then significantly increases the cost of solar electricity.

To avoid shutting down production at sunset the electricity can be generated from wave and/or tidal energy. The wave and/or tidal energy farm can be scaled to ensure that there is always sufficient power to keep the electrolyzers operating within their production range. However, during the day light hours there will be situations when there is too much solar and wave energy combined. Thus, if this excess energy can be utilised somewhere else in the process it will decrease the overall cost of the hydrogen.

As hydrogen requires water, the excess wave and/or tidal energy can be used to purify the fresh water. The current most efficient form of water desalination is reverse osmosis. However, this is about 20-30% efficient. Thus, about 3-4 tonnes of sea water are needed to produce 1 tonnes of pure water. With these large quantities of water, it is preferential to use a centrifugal water pump directly connected to a nearshore wave energy converter, thus efficiently using infrastructure and avoiding additional equipment. By connecting to a wave energy converter that smooths the power output to the pump, the pressure supplied to the reverse osmosis membranes is smooth and avoids damaging the reverse osmosis membranes.

The seawater is thus pumped ashore, typically during the daylight when there is an excess of power and passed through a desalination plant and the pure water is stored before being required by the electrolysis plant or other consumers of desalinated water.

As described above, it is known that Green Hydrogen is produced from pure water and with renewable energy. Pure water is a limited resource, especially in areas with a strong solar energy potential. Also, renewable energy, such as solar and wind energy, is intermittent. Intermittency in the power feed of a large-scale hydrogen production plant causes shutdowns, cold restarts, reduction in reliability and higher costs. It is difficult to predict the production of solar and wind energy and electricity production can fall steeply, which will cause a sudden shutdown without a transitional means of power. Stopping and restarting the process will damage the equipment, reduce efficiency and increase the cost.

The problem related to the intermittency of renewable energy has been tried to be solved by connecting the hydrogen production process to a variety of renewable energy resources on, for example, a floating structure that contains wind, solar, tidal and wave energy converters.

It is difficult to select the correct size of electrolysis plant. Electrolyzers have a dynamic range of operation (typically 15-100%). If the production falls below 15% the electrolysers are sequentially is shut down. Thus, the plant cannot be dimensioned for the maximum production of all renewable generators because electricity production will often fall to very low levels at night and cause the plant to shut down. This also leads to a low utilisation rate of the electrolyzers and thus a higher cost of hydrogen.

A strong electrical connection is normally required, but this is not available in remote locations that have an abundance of renewable energy. Intermittent forms of renewable energy have been coupled to battery storage in remote locations where a grid connection is not available. Battery solutions need to be over dimensioned in order to suddenly supply high power levels to compensate for the sudden drop electricity production, for example if a cloud passes over a solar array. Alternatively, a faster acting type of electroyzer can be used, but these have a lower efficiency than slower acting types, such as solid oxide

Other ideas have included batteries to store energy during the day and feed the production at night. But this suffers from the additional cost and inefficiency of battery storage and does not take into consideration the production of water.

If the plant is dimensioned for the minimum production, for example at night, then renewable energy produced during periods of peak production will be wasted, or the electricity needs to be fed to the electrical transmission grid, which requires proximity to a strong electrical transmission grid and additional costly equipment. Thus, earlier solutions have only incorporated small quantities of renewable energy generation or not considered the situation when energy falls to a minimum and the energy still required to purify water.

One known system is presented in international patent publication No. WO 2014/196921 A1. The system is a water based modular power plant system with several renewal energy collecting modules and a hydrogen production module comprising an electrolysis system for producing hydrogen. In this system, one or more renewable energy collecting modules can be used to provide energy to the hydrogen production module. However, this solution has the problems described in the previous paragraph. Another problem is that an electrolysis plant has a high capital cost, thus it is important that the electrolysis plant has a high utilization in order to increase the economic viability of hydrogen production. Using photovoltaic solar power alone will result in a low utilization of the electolyzers and energy storage or external energy will be required to continue operations through the nighttime. This increases the cost.

The object of the present invention is to eliminate the drawbacks described above and to achieve a reliable, compact, economical and efficient arrangement to produce Green Hydrogen, in which arrangement the production of pure water is optimized and shutdowns of the hydrogen production facility are avoided. Another object of the present invention is to decrease the cost of large-scale Green Hydrogen production. The arrangement to optimize the production of hydrogen according to the invention is characterized by what is presented in the characterization part of claim 1. Other embodiments of the invention are characterized by what is presented in the other claims.

This invention relates to an arrangement to optimize the production of hydrogen, the arrangement comprising at least a solar energy unit and a wave and/or tidal energy recovery system, which are arranged to produce renewable energy, a water purification unit and an electrolysis unit, which is arranged to produce hydrogen from pure water produced by the water purification unit, and the electrolysis unit and the water purification unit are powered by the renewable energy produced by the solar energy unit and the wave and/or tidal energy recovery system. The arrangement comprises a buffer unit, into which pure water is supplied from the water purification unit during periods when the production of the renewable energy exceeds the need of energy of the electrolysis unit.

The solution of the invention has significant advantages over the solutions of the prior art. One advantage is that the solution of the invention optimizes the production of hydrogen and pure water and avoids the need to shut down the hydrogen production facility and increases the utilization of the overall process. Thus, decreasing the cost of large-scale Green Hydrogen production by increasing the economic viability of the plant. Also, additional revenue streams are gained through water production.

The utilization of the overall Green Hydrogen production is optimized, thus reducing the costs. Export of excess energy to the national electricity transmission grid can be omitted, thus avoiding the need for proximity to the grid and the costly equipment needed to make the connection.

In this invention the pure water storage acts as a buffer ensuring that the electrolysis plant operates at optimum efficiency and no energy is lost from the renewable power generation. Thus, customers will optimally utilise the renewable energy resource, create large quantities of hydrogen that fresh water resources could not sustain and also reduce the cost of Green Hydrogen and desalinated water by harnessing low cost intermittent solar energy.

In the following, the invention will be described in detail by the aid of examples by referring to the attached simplified and diagrammatic drawings, wherein

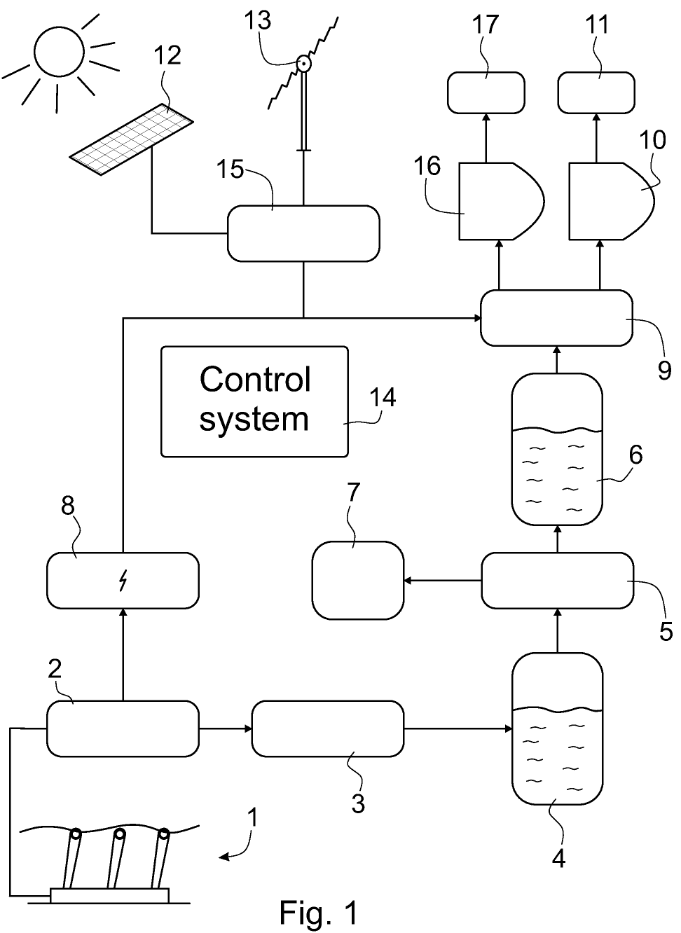

FIG. 1 presents a simplified diagram of the main idea of the invention.

FIG. 1 presents a simplified diagram of an arrangement or system, in which the main idea of the invention is applied. This is just one example embodiment of the invention. The arrangement comprises a wave energy recovery unit 1 with panels that are for example hinged onto a base at the bottom of the sea and arranged to make reciprocating motion caused by the kinetic energy of the waves and/or tidal currents. The recovered energy is transferred through collecting means and cables or pipes to the use of a wave and/or tidal energy recovery system 2 that can be for instance a collecting station situated on shore or in the wave recovery unit. The wave and/or tidal energy recovery system 2 is connected to a water pump subsystem 3 which is arranged to pump seawater to a sea water tank 4. The arrangement comprises also a water purification unit 5 which is arranged to produce pure water. Advantageously, the water purification unit 5 is a reverse osmosis desalination unit which is arranged to produce pure water from sea water. Reverse osmosis is commonly known water purification technique and it is not explained here more precisely. The arrangement further comprises a buffer unit 6 provided with one or more tanks for purified water, to which pure water is pumped from the water purification unit 5. A brine diffuser unit 7 is also connected to the water purification unit 5 and brine generated in the reverse osmosis process is directed to the brine diffuser unit 7.

The wave and/or tidal energy recovery system 2 is connected also to an electrical generation unit 8 provided with one or more electrical generators which are arranged to produce renewable energy from waves and tidal currents. The buffer unit 6 and the electrical generation unit 8 are connected to an electrolysis unit 9 which is arranged to produce hydrogen by electrolysis. The electrolysis unit 9 is connected to a hydrogen storage tank or tanks 10, in which the produced hydrogen is stored. The electrolysis unit 9 is provided with one or more electrolyzers.

In this embodiment of the invention, the arrangement comprises also a hydrogen processing means 11, which is for example a methanation process or delivery trucks, and one or more oxygen storage tanks 16 and an oxygen processing means 17. The oxygen storage tanks 16 are connected to the electrolysis unit 9 like the hydrogen storage tanks 10. So, also oxygen produced by the electrolysis unit 9 is utilized.

In this example embodiment of the invention, the arrangement comprises also a solar energy unit 12 and a wind energy unit 13. These units 12 and 13 are arranged to produce renewable energy to be used as energy sources for the electrolysis unit 9.

The arrangement comprises also a control system 14 which is arranged to control and adjust of the different units of the arrangement to optimize the energy production of the different energy production units of the arrangement based among other things on wave and weather predictions.

During periods of excess renewable energy production, in excess of the electrolysis unit 9 capacity, the buffer unit 6 is filled. The buffer unit 6 forms a buffer for the process and provides flexibility to size the system for optimal utilisation of the renewable energy.

Areas with strong solar energy often have a shortage of desalinated water and excess water is also sold as an additional revenue source.

In one advantageous embodiment of the invention, there are two hydraulic motors inside the wave energy converter and one motor is connected to a water pump and the other is connected to an electrical generator. The hydraulic oil is switched between the motors, via a hydraulic block, depending on the operational mode.

Wave and/or tidal energy is used to produce both electricity to feed the hydrogen electrolysis process and/or pure water to feed the hydrogen production process and feed other processes that require desalinated water. There are novel features in the process that allow other forms of renewable energy to be combined to improve the efficiency and cost. This creates a win-win situation so that the cost of Green Hydrogen is lower when other cheaper forms of renewable electricity generation are combined to feed the process, but without wave and/or tidal energy the utilisation, reliability and efficiency of the hydrogen production process is low.

In the situation when renewable electricity production is more than needed by the electrolyzers of the electrolysis unit 9, and associated equipment, then the wave energy converter will switch from driving an electrical generator to produce electricity to instead drive a water pump that feeds pressurized water to a reverse osmosis process. This water is then stored in a pure water storage and is made available to the electrolysis process or sold to other consumers. When renewable energy is less abundant then the wave energy units will switch from producing pure water and feed the plant with electricity to ensure that the electrolyzers do not shutdown. Thus, the pure water storage tank allows the plant to be optimally dimensioned to use both wave energy and more intermittent renewable energy resources, such as solar energy, and with the enhanced predictability of wave energy the system can be kept at optimal levels of production.

In order to compensate for the sudden drop in solar and/or wind energy, the wave energy converter incorporates a form of energy accumulation that allows for a high rate of charge and discharge as well as the capability to provide the sufficient number of cycles over the lifetime of a project. Hydraulic accumulators are well suited to this application. When the renewable energy power level suddenly drops the accumulated energy in the wave energy converter quickly releases energy to supply the electrolysis process. In the case of hydraulic accumulators, the hydraulic oil flows through the hydraulic motors that drive the electricity generator. In this way the electrolysis process can be ramped up and down in a more controlled manner, thus allowed for a greater level of control and optimization. Thus, allowing the use of slower acting higher efficiency electrolyzers, such as solid oxide type. So, the arrangement comprises also an accumulator system 15.

The produced hydrogen and water are supplied to consumers using a logistics network. In order to operate most efficiently, it is important that the logistics network is able to predict operations several days ahead of time. For example, a maintenance operation on a tanker truck requires several days. The advantage of using wave energy is the high predictability over several days ahead. Thus, during the design phase the hindcast wave, solar and wind data is used to predict the optimal configuration of the logistics chain as well as pure water, hydrogen and oxygen storage. In operation, the wave energy prediction software is coupled to the logistics planning process and allows planning several days ahead. The planning can be done by the control system 14 or by a separate planning unit.

Advantageously, the arrangement comprises nearshore wave energy converters that can switch between producing electricity and pumping water. For example. the wave energy is captured and stored in hydraulic accumulators. This accumulated energy is then used to run one or more hydraulic motors and maintain a constant rate of rotation that changes slowly. The motors are then connected to either an electricity generator that maintains smooth electricity production or a centrifugal water pump that maintains a constant pressure and high flow in a long pipeline. The system can be switched between water and electricity as needed.

In addition, there is a reverse osmosis plant and a pure water storage tank that stores the production of the reverse osmosis plant before feeding it to the electrolysis plant.

In addition, there is a weather prediction system that predicts the wave and/or energy and allows optimal operation.

The electrolyzers are sized so that 15% (this value can change depending on the type and number of electrolyzer units) load equals the lowest power level of renewable energy, within a selected probability and period. Based on this the full-size power rating of the electrolyzers can be determined. The maximum power of renewable energy, within a selected period and probability, minus the maximum power demand of the electrolyzers equals the power balance, excess or deficit.

This is plotted as a time series. The power excess is then divided by the production rate of the reverse osmosis plant and this rate minus the demand of the electrolysis is integrated to determine the volume of water in excess. This excess volume is a first indication of the size of the water storage tank, but this must be compared against the flow from the tank during energy deficit to ensure that the tank does not completely empty or overflow due to residual levels during refill phases.

This can be studied and optimized using a time domain simulation. The time domain simulation uses hindcast data to calculate the expected production power of each renewable energy source at any given time and the ratio between those levels.

Furthermore, this can be further refined by only considering that the excess power from the wave and/or tidal energy recovery system 2 is used to feed the reverse osmosis plant, i.e. water pumps onboard the wave and/or tidal energy recovery system 2 provide pressurized water instead of electricity.

By using mixture of renewable energy sources and incorporating wave energy the utilization of the electrolysis plant can be kept high. But in addition, by taking into consideration the energy needed to produce pure water and the variability in the supply of renewable energy a pure water buffer tank ensures the entire system is kept at a high utilization level and additional revenue is sourced from the pure water. Thus, reducing the overall cost of Green Hydrogen and increasing the resilience of local communities by providing potable water.

The accumulated energy in the wave energy convertors provides energy that allows the plant to ramp down to a safe state if energy from solar or wind suddenly drops.

If this system is connected to the grid, then the feature can also provide frequency control in that when the grid frequency falls the accumulators in the wave energy convertors feed electricity to the grid which increases the frequency. If the grid frequency increases the electricity from the electricity grid can be diverted to the electrolyzers and wave energy can be diverted to water production, thus reducing the grid frequency.

The idea with the pure water tank is to allow the process to be optimized. But the energy consumption to produce water is not that great when compared to the energy needed to produce hydrogen.

The main issue at running electolyzers at partial load is the potential for contamination in the gas produced - small quantities of hydrogen in the oxygen can cause explosive mixtures. The electrodes can also degrade. Solar is highly intermittent and can quickly fall to zero when clouds pass over. To avoid this, the wave and/or tidal energy recovery system power take off technology used to smooth wave and/or tidal energy can also be used to smooth the solar energy, i.e. if the solar drops the accumulated energy in the hydraulic accumulators of the power take off will continue to feed power bridge the gap or to allow the process to ramp down in a safe manner.

In addition, during the daylight hours the wave and/or tidal energy recovery system accumulators are kept as full as feasible to respond to sudden drops in solar power. Wave by wave prediction helps to optimise this. During the night the accumulators are operated to optimise the wave energy delivered as electricity.

Longer term prediction of wave energy will also be used.
If a drop in wave energy during the following night is predicted, then gas volumes can be increased in hydrogen and oxygen gas buffer tanks. The purpose of this is to keep the impurities produced at partial loads below the explosive limit.
the pure water tank can also act as a thermal mass. The process is maintained at an optimal temperature. If a deviation in the process is predicted this temperature will change. In this case more pure water can be produced ahead of time to act as a thermal mass to reduce the change in process temperature.
If it is forecast that the renewable energy will fall to zero in the following days then the electrolysis process can be shut down safely to avoid the explosion risk due to build up of contaminating gases at low loads.
Alternatively, if renewable energy is predicted to fall to very low levels for a short period (parts of a day) in the coming days then reserve hydrogen and oxygen tanks can be filled and used to power the process via a fuel cell and avoid a shutdown. This alternative is used after making an economic analysis taking into account the electrolyzer manufacture’s recommendation for the maximum shutdowns during the equipment life, the historical weather data at the site and operational experience to determine the expected shutdowns in the life and the number of shutdowns performed so far.

It is obvious to the person skilled in the art that the invention is not restricted to the examples described above but that it may be varied within the scope of the claims presented below. Thus, for example, the structure and positions of different units can be different from what is presented.

1. Arrangement to optimize the production of hydrogen, the arrangement comprising at least a solar energy unit (12) and a wave and/or tidal energy recovery system (2), which are arranged to produce renewable energy, a water purification unit (5) and an electrolysis unit (9), which is arranged to produce hydrogen from pure water produced by the water purification unit (5), and the electrolysis unit (9) and the water purification unit (5) are powered by the renewable energy produced by the solar energy unit (12) and the wave and/or tidal energy recovery system (2), and the arrangement comprises a buffer unit (6), into which pure water is supplied from the water purification unit (5) during periods when the production of the renewable energy exceeds the need of energy of the electrolysis unit (9), characterized in that during periods when the production of the renewable energy is lower than what is needed by the water purification unit (5) and the electrolysis unit (9), the produced renewable energy is arranged to be used by the electrolysis unit (9) and pure water is supplied from the buffer unit (6) to the electrolysis unit (9).

2. Arrangement according to claim 1, characterized in that during periods when the production of the renewable energy exceeds the need of energy of the electrolysis unit (9), a part of the renewable energy produced by the arrangement is arranged to feed power to the electrolysis unit (9) and the rest of the renewable energy produced by the arrangement is arranged to feed power to the water purification unit (5) to produce pure water and supply it into the buffer unit (6).

3. Arrangement according to claim 1, characterized in that during periods when the production of the renewable energy exceeds the need of energy of the electrolysis unit (9), the wave and/or tidal energy recovery system (2) is arranged to feed power to the water purification unit (5) to produce pure water into buffer unit (6), and the solar energy unit (12) is arranged to feed power to the electrolysis unit (9).

4. Arrangement according to claim 1, characterized in that the arrangement comprises a control system (14), which is arranged to control and adjust different units of the arrangement to optimize the energy use of the different energy production units of the arrangement.

5. Arrangement according to claim 1, characterized in that the arrangement comprises means to predict wave conditions several days ahead of time.

6. Arrangement according to claim 1, characterized in that arrangement comprises an accumulator system (15).

7. Arrangement according to claim 1, characterized in that the arrangement comprises a wind energy unit (13) arranged to produce renewable energy for the water purification unit (5) and the electrolysis unit (9).

8. Arrangement according to claim 2, characterized in that during periods when the production of the renewable energy exceeds the need of energy of the electrolysis unit (9), the wave and/or tidal energy recovery system (2) is arranged to feed power to the water purification unit (5) to produce pure water into buffer unit (6), and the solar energy unit (12) is arranged to feed power to the electrolysis unit (9).

9. Arrangement according to claim 2, characterized in that the arrangement comprises a control system (14), which is arranged to control and adjust different units of the arrangement to optimize the energy use of the different energy production units of the arrangement.

10. Arrangement according to claim 3, characterized in that the arrangement comprises a control system (14), which is arranged to control and adjust different units of the arrangement to optimize the energy use of the different energy production units of the arrangement.

11. Arrangement according to claim 2, characterized in that the arrangement comprises means to predict wave conditions several days ahead of time.

12. Arrangement according to claim 3, characterized in that the arrangement comprises means to predict wave conditions several days ahead of time.

13. Arrangement according to claim 4, characterized in that the arrangement comprises means to predict wave conditions several days ahead of time.

14. Arrangement according to claim 2, characterized in that arrangement comprises an accumulator system (15).

15. Arrangement according to claim 3, characterized in that arrangement comprises an accumulator system (15).

16. Arrangement according to claim 4, characterized in that arrangement comprises an accumulator system (15).

17. Arrangement according to claim 5, characterized in that arrangement comprises an accumulator system (15).

18. Arrangement according to claim 2, characterized in that the arrangement comprises a wind energy unit (13) arranged to produce renewable energy for the water purification unit (5) and the electrolysis unit (9).

19. Arrangement according to claim 3, characterized in that the arrangement comprises a wind energy unit (13) arranged to produce renewable energy for the water purification unit (5) and the electrolysis unit (9).

20. Arrangement according to claim 4, characterized in that the arrangement comprises a wind energy unit (13) arranged to produce renewable energy for the water purification unit (5) and the electrolysis unit (9).
